(19) United States
(12) Patent Application Publication
(10) Pub. No.: US 2004/0200087 A1
(43) Pub. Date: Oct. 14, 2004

(54) Roofing tool

(76) Inventor: Robert Killen, Monroe, GA (US)

Correspondence Address: Womble Carlyle Sandridge & Rice, PLLC, P.O. Box 7037, Atlanta, GA, 30357-0037, US

(21) Appl. No.: 10/412,368

(22) Filed: Apr. 11, 2003

(51) Int. Cl. G01D 21/00

(52) U.S. Cl. 33/613

(57) ABSTRACT

A tool is provided that is used to size a roofing panel to be installed adjacent a hip or valley edge of a roof. The roofing tool generally includes a channel formed to fit upon a rib of a roofing panel. The roofing tool also includes a member with an end that extends perpendicularly from a centerline of the channel a distance approximately equal to the distance separating two opposed side ribs of a roofing panel. A method of sizing a roofing panel using the roofing tool is also provided.

### TECHNICAL FIELD

The present invention is directed to roofing materials and tools and, more specifically, to tools used for determining the angled cuts for sheet metal roofing panels.

### BACKGROUND

In the roofing industry, metal sheets commonly are installed as the outermost finished layer of both commercial and residential roofs. Although numerous vendors manufacture and market such roofing sheets, a vast majority of these sheets include the common characteristic of raised ribs or ridges extending lengthwise down the sheets. Generally, these ribs are spaced along the width of a panel such that the distance between a centerline of one outermost rib is thirty-six inches to the centerline of the opposed outermost rib. Depending upon the manufacturer and the particular style, the rib profiles of different roofing panels may vary between rounded, squared, beveled, and other various alternatives. However, generally, in each instance, the distance between the centerline of a rib located along one lengthwise side of the panel and the centerline of the rib located along the opposed lengthwise side of the panel is about thirty-six inches.

Currently, when a roofing team is installing a sheet metal roof, two team members must be positioned on the roof to take the measurements necessary to make the cuts in the panels that are to be installed adjacent the angled edges of the roof. The angled edges include sections that are commonly referred to as hips and valleys. As used herein, the term “hip” refers to an angled edge bounded by surfaces that are oriented more than 180° apart, while the term “valley” refers to an angled edge bounded by surfaces that are oriented less than 180° apart. Generally, a roof face extends down from a hip and up from a valley. For example, the ridgeline extending from the apex of the roof downward to the bottom corner would encompass a hip. Whereas a valley would be formed by the juncture of a primary roof slope and a gable. Normally, one of the two team members positioned on the roof holds a straight-edge or plum line, while the other team member measures the distance to the ridgeline. The measurement is then conveyed to a third team member, usually positioned on the ground, who then marks that measured distance on a side of the panel to be installed adjacent to a hip or valley and cuts an angled side so that it is flush with the hip or valley. The panel is then raised to the roof and installed. Unfortunately, this process leads to inaccuracies that result in incorrectly sized panels that do not fit adequately on the roof. Oftentimes, an incorrectly cut panel must be discarded. Inaccuracies arise so frequently in this process that the cost of these mistakes becomes a significant percentage of the overall cost of the roof. The increased cost includes both the cost of incorrectly cut panels and the increased cost of labor due to frequent repetition of the measuring and trimming process. Consequently, a tool is needed that provides simple and accurate measurements for sizing in metal roof panels.

### SUMMARY

The present invention provides a tool for sizing metal roofing panel that is to abut a hip or a valley of a roof. A tool of the present invention generally includes a body having a channel formed therein. The channel is configured to be placed astride an outermost rib of an installed roofing panel adjacent to the position where the panel to be sized will be installed. The tool also includes an end that extends perpendicularly from a centerline of the channel, a distance that corresponds to the distance between the centerlines of the two outermost ribs of a roofing panel. This distance is thirty-six inches for most metal roofing panels. Thus, when the tool is used to size a panel to be installed adjacent a hip or valley edge, the tool is placed astride the proximate outermost rib of the adjacent roofing panel and then aligned so that the end of the tool abuts the hip or valley, thereby providing a reference point for measuring the distance that then will be used to size the length of the panel side that will be next to the hip or valley.

In one embodiment, the tool of the present invention includes a body including a channel formed therein and an end extending thirty six inches from the centerline of the channel. The channel is formed in a first member of the body and the end is formed on a second member of the body. The first member forms a right angle and, optionally, a T-shape with the second member. The end of the second member includes one or more corners or vertexes that are used as reference points for making measurements with the tool. In one embodiment, the end includes a first corner and a second corner that correspond to a first reference line and a second reference line, respectively, formed on the first member of the tool. The tool generally can be formed of a metal such as aluminum, or other durable material.

The present invention also includes a method of sizing a roofing panel that is to be installed adjacent a hip or valley edge of a roof. The method generally includes positioning a tool on a roofing panel, such that a channel formed in the body of the tool straddles a rib of the roofing panel. The tool is aligned on the rib of the roofing panel so that an end of the tool contacts the edge of the roof. The distance from the end of the panel to the point along the channel that is perpendicular to the point of contact of the tool with the edge of the roof is then measured. The measurement is then applied to the roofing panel that is being sized, and the panel is trimmed to form an angled side that fits flush with the hip or valley edge.

These other aspects of the present invention are set forth in greater detail in the description below and in the accompanying drawing figures.

### BRIEF DESCRIPTION OF THE DRAWINGS

FIG. 1 is a perspective view of a roofing tool encompassing aspects of the present invention.

FIG. 2 is a top view of the roofing tool of FIG. 1.

FIG. 3 is a side view of a section of the roofing tool of FIG. 1.

FIG. 4 is a perspective view of a section of a metal roofing panel.

FIG. 5 is a top view of the roofing panel FIG. 4 with the roofing tool of FIG. 1 placed thereon.

FIG. 6 is a perspective view of another embodiment of a roofing tool encompassing aspects of the present invention.

FIG. 7 is an elevational diagrammatic view of a building with a roof that includes both a valley and hips showing representations of a roofing tool at various positions where the tool is placed during use, with various roofing panels arranged below with trimmed sections shown in phantom line.

FIG. 8 is a side view of the roofing panel of FIG. 4.

FIG. 9 is a perspective view of the roof of a building with the roofing tool of FIG. 1 being used thereon.

### DETAILED DESCRIPTION

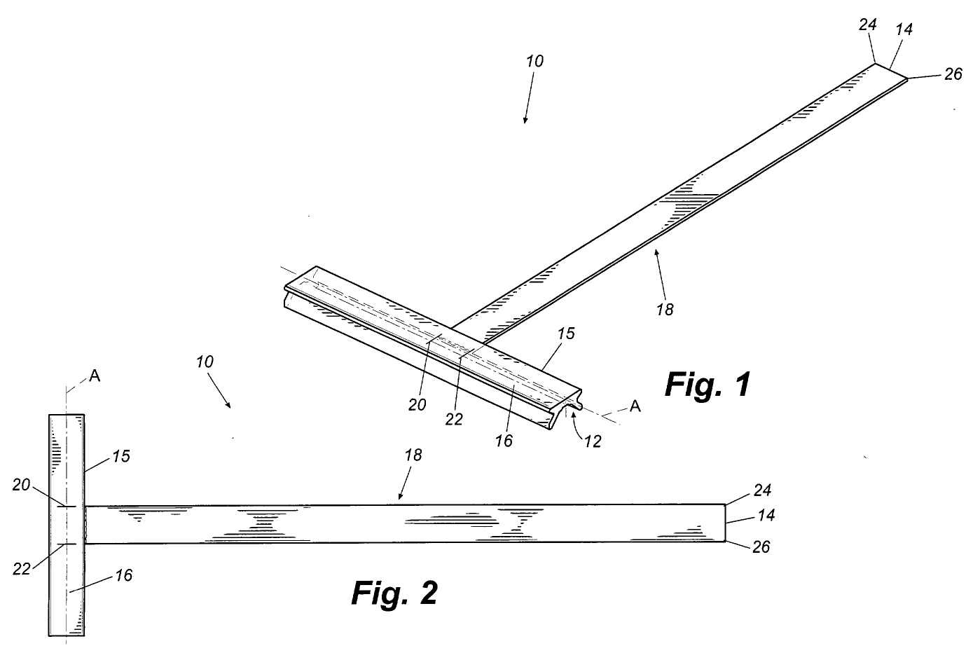

Referring to the drawings, FIGS. 1-9, in which like numerals refer to like parts throughout the several views, FIG. 1 depicts a roofing tool 10 that encompasses aspects of the present invention. The roofing tool 10 includes a first member 16 integrally formed with a second member 18. The first member 16 includes a channel 12 that is shaped to fit over a rib of a roofing panel. The second member 18 includes a reference end 14, which is separated from the midpoint or centerline A of channel 14 by a distance that corresponds to the distance between the centerline of two opposed ribs that each extend longitudinally along opposed sides of a metal roofing panel. For many conventional metal roofing panels, this distance is thirty-six inches from the centerline of one side rib to the centerline of the opposing side rib. Therefore, the distance between the reference end 14 and the centerline A of channel 12 is thirty-six inches in one embodiment of the roofing tool 10, as measured perpendicularly.

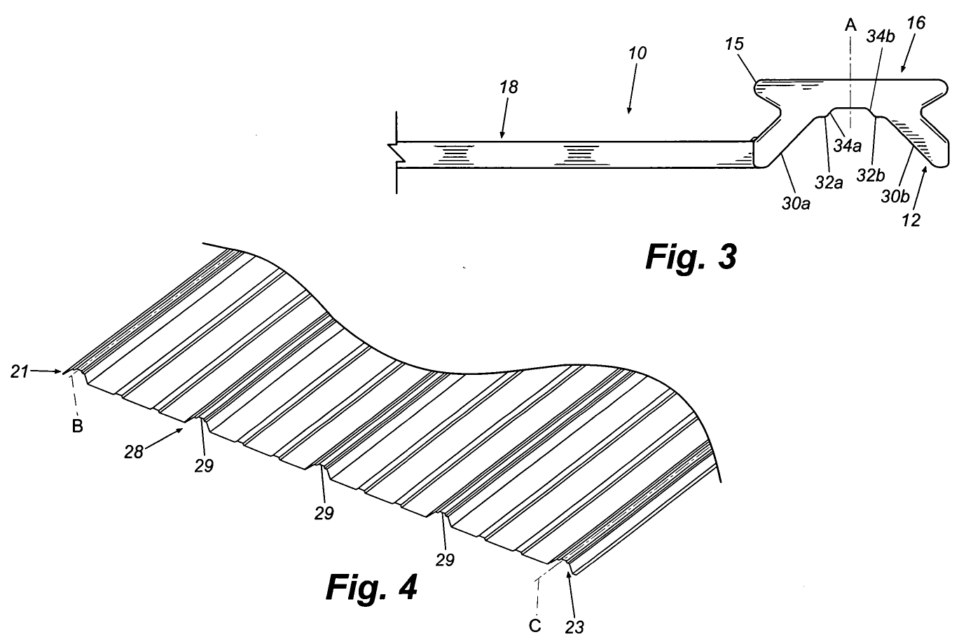

In the embodiment shown in FIGS. 1, 2 and 3 the roofing tool 10 is T-shaped with the second member 18 being joined to the first member 16 at the midpoint of the first member 16, thereby forming a right angle between the two members. The roofing tool 10 also can include one or more reference marks formed on the roofing tool 10. For example, as shown in FIGS. 1 and 2, the roofing tool 10 includes a first reference mark 20 and a second mark 22 formed on first member 16. The first and second reference marks 20 and 22 correspond to the first and second corners 24 and 26, respectively, of reference end 14. While second member 18 is shown as a generally rectangular piece having first and second corners 24 and 26 on reference end 14, the present invention also encompasses roofing tools that include a second member or major leg having but one vertex that is used as the reference point. For example, the present invention encompasses a roofing tool having, instead of a rectangular second member, a rod or alternatively shaped second member that includes a reference end that ends in a point and only one reference mark. In each case, the location of the reference mark corresponds to the perpendicular alignment of the corner or vertex of the reference end with the channel.

The channel 12 of the roofing tool 10 of the present invention generally is shaped so as to securely fit, straddle or seat on or around a rib of a roofing panel. As shown in FIGS. 1 and 2, the channel 12 may include a profile that generally corresponds to the profile of the ribs 21, 23 and 29 of a roofing panel 28 as shown in FIGS. 4, 5 and 8. The profile of the ribs 21, 23 and 29 of the roofing panel 28 is found to be the profile of many, if not most, ribs of metal roofing panels currently in use. As shown in FIG. 3, the channel 12 includes a first pair of opposed inclined sidewalls 30a and 30b, each of which are connected to one of a pair of opposed shoulders 32a and 32b. The channel 12 also includes a second pair of opposed inclined sidewalls 34a and 34b. The profile of the channel 12 allows the first member 16 to securely seat upon a rib 21 or 23 the roofing panel 28. Thus, the channel 12 is congruent with the ribs 21, 23 and 29 of the roofing panel 28.

While the channels of the roofing tools shown in the drawings are continuous and integrally formed with the other parts of the tools, the present invention also encompasses roofing tools which include channels that are either substantially shorter than the channels shown in the drawings or discontinuous or open at the top. Furthermore, the present invention also encompasses tools which have channels that are fastened or removably attached to the other tool parts by fasteners such as bolts, screws, clips, pins, hinges and other fasteners.

The roofing tool 10 also includes a handle 15 formed in the first member 16. The handle 15 facilitates placement and manipulation of a roofing tool 10 and generally includes indentations in the side walls of the first member 16.

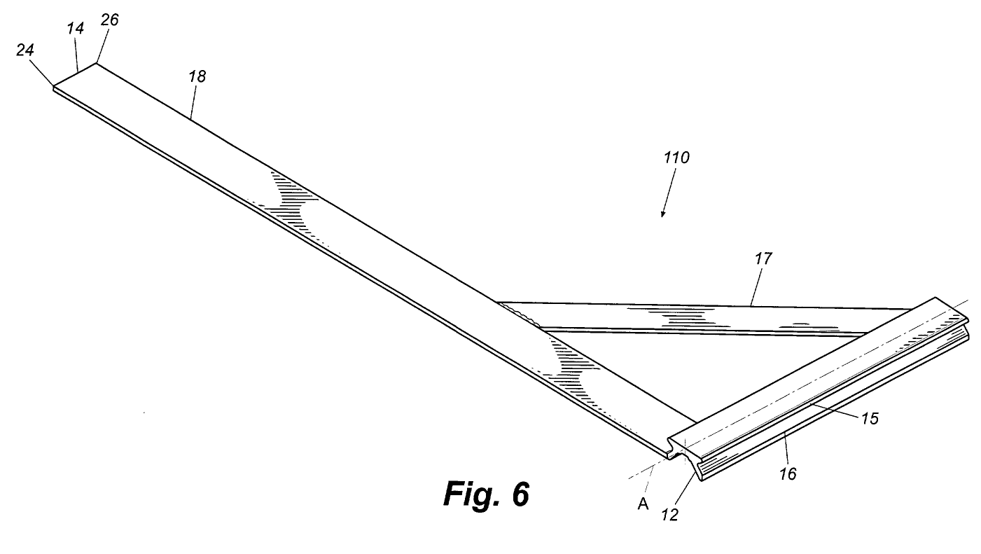

While one embodiment of the roofing tool 10 is generally T-shaped, the present invention also encompasses alternatively shaped tools, such as roofing tool 110 shown in FIG. 6. The roofing tool 110 also includes a first member 16 and a second member 18, but instead of second member 18 being connected to first member 16 at an intermediate point, the second member 18 is connected at an end of the first member 16, so as to provide a generally L-shaped configuration to the roofing tool 110. The roofing tool 110 optionally can include a stabilizer 17 that is connected to both the first member 16 and a second member 18 so as to limit bending or warping of the tool members.

The roofing tool of the present invention can be formed of metal, polymeric resin or other suitable material. The roofing tool can be stamped, molded or its constituent parts extruded and welded together to form the tool. In one embodiment, the roofing tool 10 is formed of aluminum. More particularly, the first member 16 is formed of an aluminum alloy, such as alloy #6063, and welded to the second member, formed of an aluminum alloy #6061, by a weld formed of an aluminum alloy #4043. The use of aluminum allows the tool to be relatively light weight, while also being rigid enough to maintain the alignment of the first and second members of the tool.

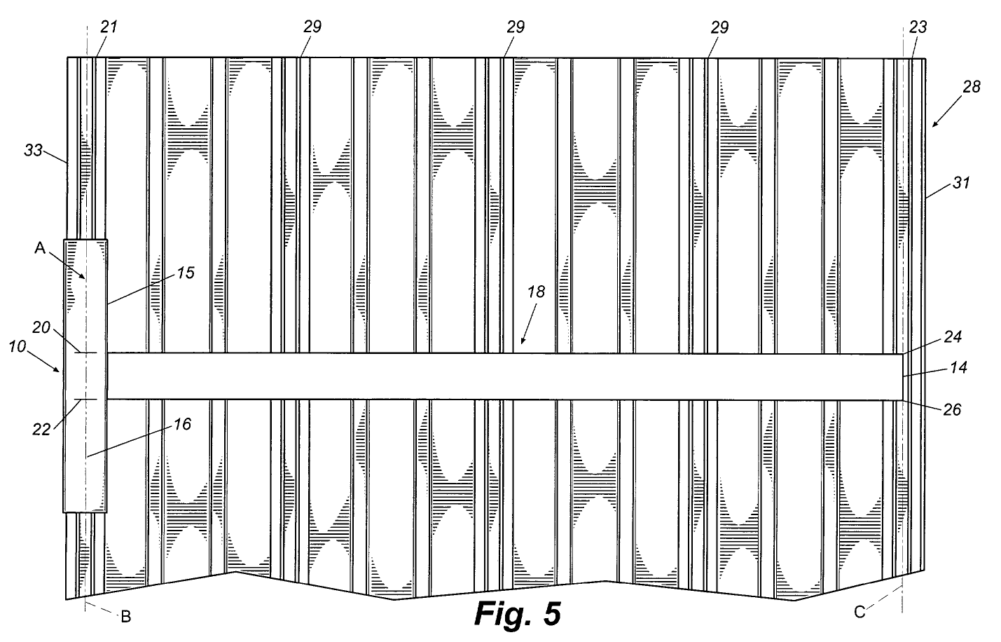

In use, the roofing tool 10 is used to determine the reference points for forming an angled side in a metal roofing panel to be installed adjacent a hip or valley edge of a roof. As shown in FIG. 5, a typical metal roofing panel 28 includes spaced ribs 21, 23 and 29 running the length of the panel. The side ribs 21 and 23 are located adjacent each longitudinal side 31 and 33 of the panel 28. As shown in FIG. 8, the distance Z between the centerlines B and C of these two opposed side ribs 21 and 23 is generally about thirty-six inches. Due to the overlap of adjacent panels when they are installed on a roof, the most convenient and accurate reference distance for sizing panels tends to correspond to the distance between the centerlines of the opposed side ribs of the panel. Consequently, when sizing roofing panels having such dimensions, a roofing tool is used that has a reference end that extends about thirty-six inches from the centerline of the channel formed in the tool.

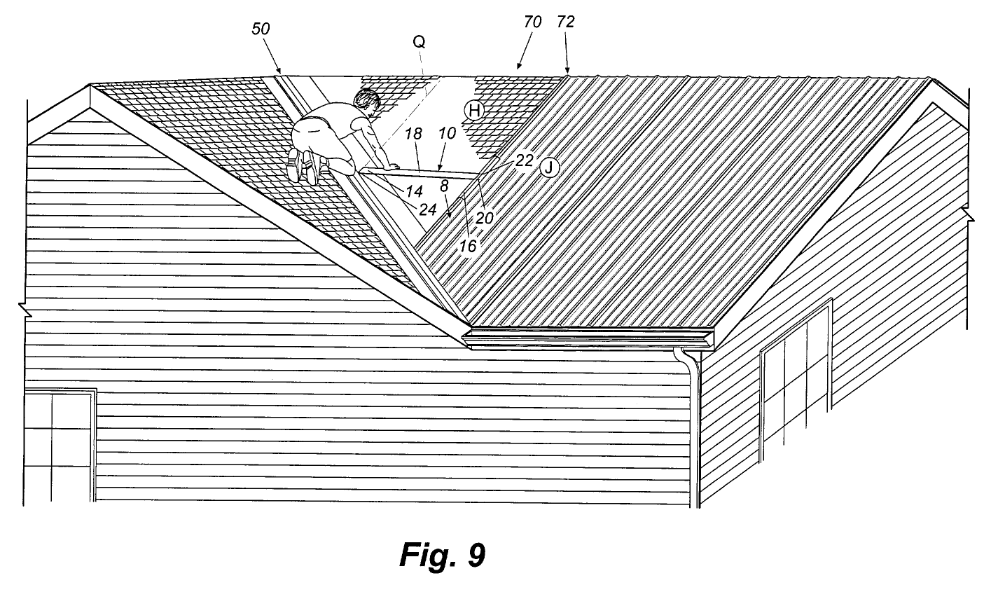

The roofing tool may be used to size roofing panels that are to be aligned adjacent either hips or valleys of a roof. As shown in FIG. 9, when an installer is making a determination as to the placement and angle of a cut for roofing panel to be installed at location H, the installer will place the first member 16 of the roofing tool 10 on rib 8 of installed panel J, which is the closest of panel J's ribs to the location H. The first member 16 of the roofing tool 10 is then moved along the rib 8 until the first corner 24 of reference end 14 contacts the edge of the valley 50 of the roof 70. Once the roofing tool 10 is in the desired alignment, the distance from the top edge 72 of the roofing panel J to the first reference mark 20 on the first member 16 of the roofing tool 10 is measured. This distance corresponds to the length of the far side Q of the panel that is to be cut and installed at location H on the roof.

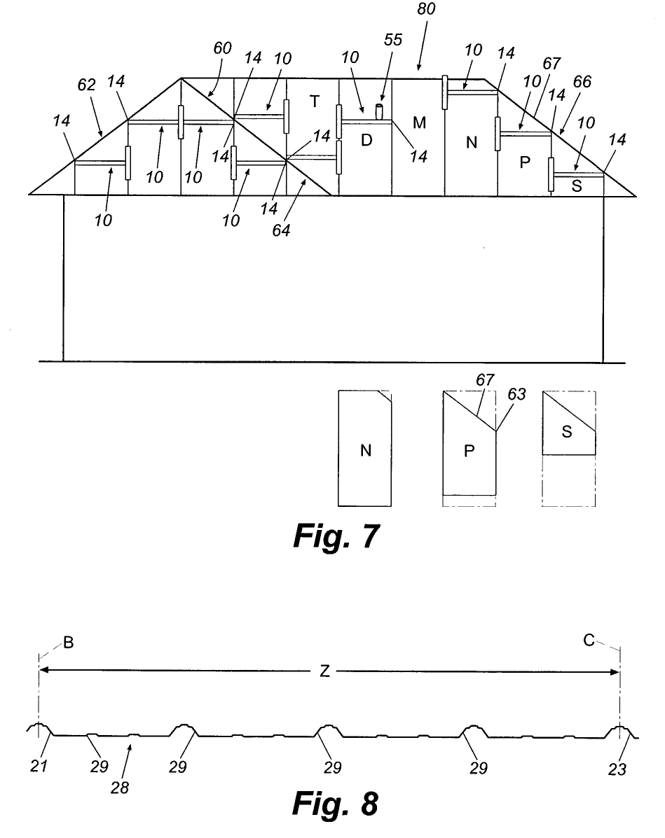

A similar alignment and measurement can be made when sizing a panel to be placed adjacent a hip of a roof. FIG. 7 illustrates a diagrammatic representation of a building with a roof 80 that includes both a valley 60 and hips 62, 64 and 66. The roofing tool 10, shown in multiple relevant alignments on the roof 80 is positioned in each relevant alignment so that the reference end 14 of the roofing tool 10 abuts the edge of the hips 62, 64 or 66 or the valley 60. When measuring adjacent a hip 62, 64 or 66, the measurement is made from the bottom side of the panel upon which the roofing tool 10 is positioned to the reference mark on the tool that corresponds to the corner of the reference end that is abutting the hip. For example, in the case of roofing panels N, P and S, the roofing tool 10 is first placed on the side rib of the panel M so that a corner of the reference end 14 abuts the hip 66. The distance from the top of the panel M to the first reference line can then be measured. The person cutting panel N can then mark the distance on the right side of panel N and make the appropriate cut from the point on the top edge of panel N corresponding to where the hip 66 begins to the reference mark on the right side of panel N. The panel N then can be installed. Next, the roofing tool 10 can be seated upon the right side rib of panel N and aligned so that a corner of the reference end 14 abuts hip 66. In order to size panel P, the length of the right side of panel N is used as the left side length of panel P. The bottom of panel P, thus, is trimmed appropriately. Next, the roofing tool 10 can be seated upon the right side rib of panel N and aligned so that a corner of the reference end 14 abuts hip 66. The distance from the top right edge of panel N down to a reference point on the roofing tool 10 corresponding to the perpendicular alignment of the corner abutting the hip with the channel is measured. The panel P is then measured from the top, and a reference point 63 is marked to correspond to the measured distance. The panel P is then trimmed to form angled side 67, which abuts hip edge 66 when panel P is installed. Similar measurements can be made to trim panel S to fit on roof 80.

The roofing tool 10 also can be used to locate the position of a pipe or similar structure on a roof face. As shown in FIG. 7, a pipe 55 extends from the face of roof 80. In order to cut an appropriately positioned hole in panel D for receiving pipe 55, the roofing tool 10 can be employed. As with the other uses of the tool, the roofing tool 10 is positioned on the right side rib of panel T and adjusted to where it abuts pipe 55. Measurements can then be made from the top of panel T down to an appropriate reference mark on roofing tool 10, as well as from the reference end 14 to the side of the pipe 55. The panel D is then cut appropriately using these measurements.

While particular embodiments of the present invention have been discussed and disclosed herein, other embodiments will suggest themselves to persons skilled in the art in view of this disclosure. Therefore, it will be understood that variations, additions, deletions, and modifications to the illustrated embodiments not specifically discussed herein may be affected without departing from the spirit and scope of the invention as set forth in the claims and that the scope of the invention should be limited only by the claims.

1. A tool for sizing a roofing panel comprising:
a body comprising a channel formed therein for alignment on a rib of a roofing panel, an end extending perpendicularly from a centerline of said channel a distance equal to a distance separating centerlines of two opposed side ribs of the roofing panel, and a reference mark formed along said body, wherein said reference mark corresponds to a perpendicular alignment of said end with said channel and wherein said reference mark is exposed when said channel is aligned on the rib of the roofing panel to enable measurement of desired distances for sizing a next roofing panel.

2. The tool of claim 1, wherein said channel is formed in a first member of said body.

3. The tool of claim 2, wherein said end is formed on a second member of said body.

4. The tool of claim 3, wherein said first member forms a right angle with said second member.

5. The tool of claim 3, wherein said first member forms a T with said second member.

6-7. Canceled.

8. The tool of claim 6, wherein said body further comprises a second reference mark formed thereon.

9. The tool of claim 8, wherein said second reference mark corresponds to a perpendicular alignment of a corner of said end with said channel.

10. The tool of claim 8, wherein said first reference mark and said second reference mark are formed on a first member of said body.

11. The tool of claim 3, wherein said body further comprises a support member interconnecting said first member and said second member.

12. The tool of claim 1, wherein said end extends perpendicularly from said centerline of said channel about thirty-six inches.

13. The tool of claim 1, wherein said channel is congruent with the rib of the roofing panel.

14. The tool of claim 1, wherein said channel comprises a first pair of opposed inclined side walls, a pair of opposed shoulders, and a second pair of opposed inclined side walls, wherein each of said opposed shoulders connect one of each of said first pair of opposed inclined side walls to one of each of said second pair of opposed inclined side walls.

15. The tool of claim 1, wherein said body is formed of aluminum.

16. A tool for sizing a roofing panel comprising:
a first member comprising a channel formed therein for straddling a rib of a roofing panel;
a second member integrally formed with said first member and comprising an end perpendicularly extending about thirty-six inches from a centerline of said channel.

17. Canceled.

18. The tool of claim 16, wherein said first member forms a right angle with said second member.

19. The tool of claim 18, wherein said first member forms a T with said second member.

20. The tool of claim 16, wherein said first member comprises a reference mark formed thereon.

21. The tool of claim 20, wherein said reference mark corresponds to a perpendicular alignment of a corner of said end of said second member with said channel.

22. The tool of claim 20, wherein said first member further comprises a second reference mark formed thereon.

23. The tool of claim 22, wherein said second reference mark corresponds to a perpendicular alignment of a second corner of said end of said second member with said channel.

24. A method of sizing a roofing panel to be installed adjacent a hip or a valley edge of a roofing comprising:
positioning a tool on a roofing panel, wherein the tool comprises a body in which a channel is formed and wherein the channel straddles a rib of the roofing panel;
aligning the channel on the rib of the roofing panel so that an end of the tool contacts the edge of the roof;
measuring the distance from an end of the roofing panel to a point on the tool perpendicular to the point of contact with the edge of the roof;
marking a point on the roofing panel being sized corresponding to the measured distance; and,
trimming an angled side on the roofing panel being sized, wherein the corner of the angle edge is formed at the marked point.

25. The method of claim 24, wherein the end of the tool extends from a centerline of the channel a distance that corresponds to a distance separating centerlines of two opposed side ribs of the roofing panel.

26. The method of claim 25, wherein the distance separating the centerlines is about thirty-six inches.

27. The method of claim 24, wherein the point on the tool is a reference mark formed on the tool.
